(19) United States
(12) Patent Application Publication
(10) Pub. No.: US 2010/0315821 A1
(43) Pub. Date: Dec. 16, 2010

(54) DIFFUSER ATTACHMENT FOR PORTABLE LAMP

(76) Inventors: Juerg Weber, Zug (CH); Matthias Holzinger, Wolfhausen (CH); Sem Hediger, Zurich (CH)

Correspondence Address: OSTROLENK FABER GERB & SOFFEN, 1180 AVENUE OF THE AMERICAS, NEW YORK, NY, 100368403, US

(21) Appl. No.: 12/780,327

(22) Filed: May 14, 2010

(30) Foreign Application Priority Data
Jun. 1, 2009 (CH) 00929/09

(51) Int. Cl. F21V 11/00

(52) U.S. Cl. 362/355

(57) ABSTRACT

The invention relates to a diffuser attachment (1) for a portable lamp, in particular helmet lamp (9), comprising a transparent or translucent housing (2) whose first end (3) is closed by a cap (8) and has a reflector element (7) in the form of a diffuser mirror and whose second end forms a base region (6) which is adapted to the outer shape of the lamp (9) in order to permit reversible fixing of the diffuser attachment to the lamp, the reflector element (7) of the light source (13) being opposite and the distance between reflector element (7) and light source (13) being at least 1 cm, in particular 1 to 20 cm and typically 5 to 10 cm when the diffuser attachment is fixed.

For removable mounting, the diffuser attachment can be connected to the lamp via a fast-action coupling mechanism, in particular via a snap, clamp, screw or bayonet coupling.

### FIELD OF THE INVENTION

The present invention relates to a diffuser attachment for a portable lamp, in particular a flashlight or helmet lamp, which permits anti-dazzle, spatial illumination of the environment, for example in a tent, recreational vehicle or trailer or in a cave.

### PRIOR ART

The prior art discloses camping lights which have a base with a receptacle for batteries and a light source and a transparent diffuser attachment mounted over the light source, fixed to the base and comprising at least one integrated reflector element. These lamps produce anti-dazzle, diffused light which ensures uniform illumination of the environment.

However, such camping lights are relatively large and therefore also relatively heavy. Particularly in the area of outdoor activities, such as trekking or mountaineering, however, it is advantageous to keep the weight and the size of the articles carried as small as possible. It is therefore the aim of the present invention to offer walkers, climbers, cave explorers, others involved in indoor and outdoor sport activity and camping enthusiasts a simple and effective possibility which enables them to dispense with additionally carrying a camping light.

The prior art discloses, inter alia, special caps for commercially available, translucent or transparent water bottles in which a plurality of solar LEDs are integrated. In this way, a liquid-filled water bottle can be converted to function as a camping light which emits diffused light which is suitable for spatial illumination at close range, for example in the interior of a tent.

Since the standard equipment of a walker or camper nowadays includes as a rule a flashlight or helmet lamp, these are also frequently used for illuminating the interior of a tent and therefore likewise offer an alternative to a camping light.

The disadvantage of a conventional flashlight or helmet lamp when used as a camping light is, however, that it produces a directed light beam from one or more LEDs and therefore achieves only a small spatial illumination. In addition, the light beam has a strong dazzling effect and is therefore disadvantageous for use in the interior of a tent.

However, the prior art also discloses modified helmet lamps in which, for producing diffused light at close range, a substantially planar diffusing lens, such as a cover, can be pushed, rotated or swiveled from a lateral parking position to directly in front of the light source. As a result, the direct dazzling effect of the light beam is reduced and somewhat better spatial illumination is achieved.

Nevertheless, the fact that the LEDs produce a more or less broad light cone owing to their recessed position in the lamp housing, in spite of the front diffusing lens attachment, remains as a disadvantage. In addition, because the diffusing lens lies in a plane with the front of the lamp housing, the luminous efficiency is not optimal.

### SUMMARY OF THE INVENTION

It is therefore an object of the present invention to provide a system which makes it possible for a commercially available portable lamp, in particular flashlight or helmet lamp, to be converted in a simple and economical manner to function as an effective camping light which offers considerable light diffusion in combination with maximum luminous efficiency and can therefore be used for uniform spatial illumination, predominantly at close range, for example in the interior of a tent or trailer.

This object is achieved by the diffuser attachment as described in claim 1. Further useful embodiments of the invention are defined in the dependent claims.

### DESCRIPTION OF THE FIGURES

FIG. 1: shows an exploded drawing of the diffuser attachment in an oblique front view

FIG. 2: shows an exploded drawing of the diffuser attachment in an oblique side view

FIG. 3: shows an exploded drawing of the diffuser attachment with helmet lamp in an oblique side view

FIG. 4: shows the diffuser attachment in the mounted state on a helmet lamp in an oblique front view

FIG. 5: shows the diffuser attachment in the mounted state on a helmet lamp in an oblique side view

FIG. 6: shows a further embodiment of the diffuser attachment in the mounted state on a helmet lamp

FIG. 7: shows a further embodiment of the diffuser attachment in the mounted state on a helmet lamp

### DETAILED DESCRIPTION OF THE INVENTION

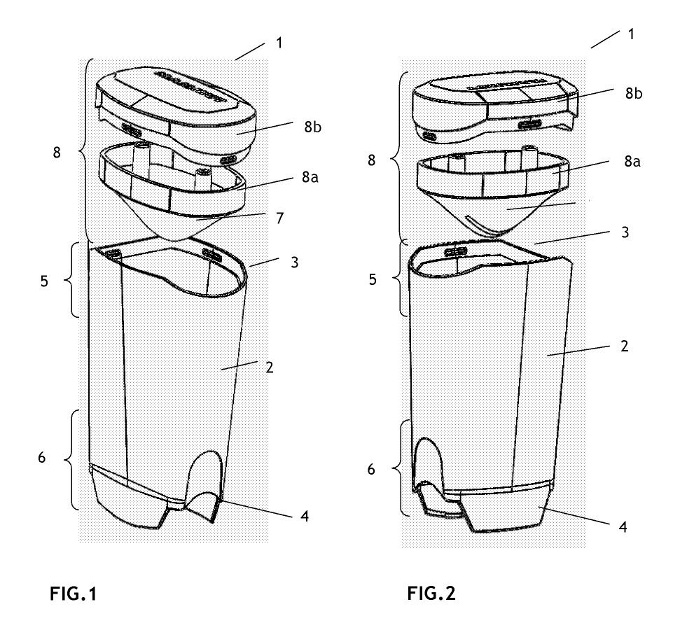

As shown in FIG. 1 and FIG. 2, the diffuser attachment according to the invention comprises, in a first embodiment, a transparent, sleeve-like housing 2 having a first end 3 and a second end 4, the first end being closed by a closure element, in particular a cap 8, and together with this forming a top region 5, and the second end 4 being open and forming a base region 6. The housing can optionally widen or taper conically toward the first end 3 and, in the region of its open end 4, has a typically rectangular, rectangle-like (=rectangular with rounded corners), oval, ellipsoidal, circular or optionally also polygonal cross-section. The closure element at the first end 3 may be formed as an integral whole with the housing 2 or may be in the form of a separate part which is to be connected to the housing. Likewise, the housing itself may also be in the form of an integral sleeve or in the form of a two-part or multipart set of individual parts which can typically be connected to one another by fast-action couplings. In the top region, the diffuser attachment has a reflector element 7 in the form of a diffuser mirror.

Here, “sleeve” or “sleeve-like” indicates the generally elongated external shape of the housing open at one end. However, shapes differing therefrom, for example a spherical or cubic shape of the housing which if need be is multi-part and is always open at one end in the ready-to-use state, are also to be included according to the invention under these definitions.

In the simplest case, the diffuser attachment is used by inverting it loosely over a commercially available lamp, typically a flashlight or helmet lamp, but, for use outdoors, fixing to the corresponding lamp is advantageous. A lamp is to be understood here also as meaning a conventional incandescent bulb with associated holder or associated lamp socket, the expression incandescent bulb here being representative of all lighting means to be screwed into a holder or a socket and having an external thread, for example also for energy-saving lamps having a spiral fluorescent tube.

The first end 3 of the housing is that which, in the state mounted on a lamp ready for use, is opposite the light source at a predetermined distance dependent on the length of the housing. According to one embodiment of the present invention, it is equipped with a cap 8 which is inseparably connected to, for example integral with, the housing or optionally removable again and which firstly carries the reflector element 7 and secondly completely closes the housing at this point.

The reflector element 7 is connected firmly or detachably on the inside of the cap 8, which in the latter case permits the possibility of replacement in the event of damage. When the diffuser attachment is mounted ready for use on the lamp, the reflector element 7 is in any case opposite the light source 14 in such a way that the light beam or light cone emerging from the light source 14 strikes the convex surface of the reflector element 7 centrally and is reflected by this as far as possible uniformly in all directions.

In a special embodiment, the cap 8 may be composed of two parts and comprise a first, approximately annular part 8a, which carries the reflector element 7, and a second part 8b, which is in the form of a cover and is detachably connected via at least one connecting element, preferably a plug connector, to the first part 8a. This design makes it possible, inter alia, for the reflector element to be removed, cleaned or economically replaced in the event of soiling or any damage.

The detachable connection between the one- or two-part cap and the housing can be effected in various ways, for example by a fast-action coupling, such as, for example, a snap, clamp, screw or plug connector.

For use with commercially available flash lights or helmet lamps, the open end 4 of the diffuser attachment according to the invention is tailored to the geometry and dimensions of said lamps. Here, flashlights are to be understood as meaning substantially rod-like flashlights.

In the simplest application of the present invention, the portable lamp, in particular flash light or helmet lamp, is a model which can be placed so that it is at least to some extent stable and in any case stands by itself on a flat surface and can emit its light perpendicularly upward. In order to achieve diffuse, spatial and anti-dazzle illumination of the relatively close environment, it is possible to use a diffuser attachment according to the invention which has, at the end 4, an internal diameter which exceeds the greatest external diameter of the lamp and can therefore be loosely inverted over said lamp.

For most applications, however, it is preferable if the diffuser attachment according to the invention can be fixed to the lamp reversibly, i.e. in a removable manner, in order to permit the use thereof in any desired position of the lamp, i.e. for example also when suspended.

For this purpose, it is intended for the diffuser attachment to have, in the base region 6 of its open end 4, fixing means which cooperate with corresponding fixing means of the lamp and which make it possible to connect it reversibly to the lamp, for example in the manner of a fast-action coupling, in particular a snap, clamp, screw or bayonet coupling.

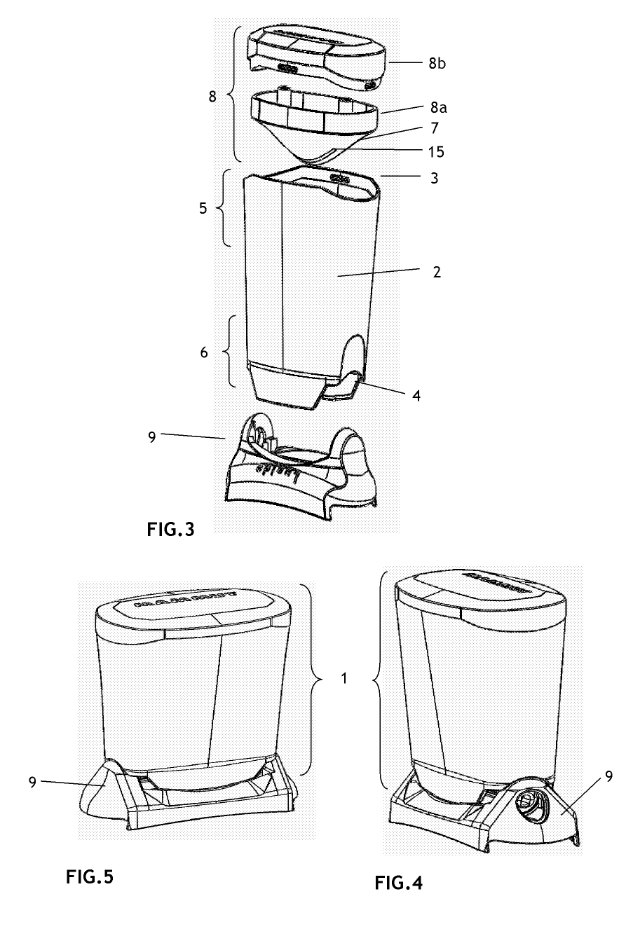

In one embodiment for a helmet lamp having an oval or rectangular cross-section of the lamp socket, the diffuser attachment according to the invention is adapted to the lamp geometry so that it can be inverted over the top of the helmet lamp on the light exit side and can be connected to said lamp by gentle pressing until a snap fastening mechanism is overcome. In this case, the cooperation of the diffuser attachment with the lamp socket takes place via corresponding edges and projections or abutments and barbs, as shown in the figures (FIGS. 3 to 6). However, such fixing can also be provided via another type of fast-action coupling, as mentioned above. In particular, a twist-lock fastener in the manner of a screw coupling with internal and external thread can be provided for lamps having a round cross-section of the lamp housing or lamp socket. Alternatively, the twist-lock fastener may also be in the form of a bayonet coupling, for example such that the diffuser attachment has an outward-directed collar in the base region 6 of the end 4 at least one point of its circumference, advantageously at least two points. This collar cooperates with at least one corresponding, circular retaining rail arranged on the lamp housing or lamp socket, by virtue of the fact that it is screwed in under said rail and firmly clamped therein or, after overcoming an obstacle in the sense of a snap coupling, snaps in and is fixed.

If the sleeve of the housing 2 is in two parts, it can, depending on the embodiment, for example with or without a hinge at the end 3, also be placed on a flange region of the lamp socket and firmly clamped in a stable manner and fixed on the lamp socket, for example by means of at least one clamp coupling. At the other end 3, the housing halves can be held together either by the hinge or, for example, by plug or snap couplings.

In order to achieve as high a luminous efficiency as possible and good diffusion of the light, the distance between the light source 13 integrated in the lamp 9 and the reflector element 7 should be at least 1 cm when the diffuser attachment is positioned ready for operation. As a rule, this distance is about 1 to not more than about 20 cm, but a diffuser attachment whose length gives a distance from the reflector element to the light source in the range of about 5 to 10 cm is sufficient for most applications. On switching on the light source 13, which generally consists of one or more LEDs but of course may also comprise a conventional incandescent bulb, the directed light beam is deflected by the reflector element 7 in lateral directions, passes through the transparent or translucent, for example opal glass-like, walls of the housing 2 and thus produces a diffuse, uniform and anti-dazzle illumination of the environment.

Although the diffuser attachment according to the invention is shown and described by way of example below in detail for use with a helmet lamp, it is evident to the person skilled in the art in this area, directly and without an inventive step, from his knowledge in conjunction with the following description, that the fundamental principles of the invention can also be applied to the use with other portable lamps, in particular flashlights, and optionally also lighting means with fixed mounting, for example freely suspended lighting means, such as incandescent bulbs and fluorescent lamps, and how said fundamental principles can be applied.

The open end 4 of the housing, which typically has a rectangular, rectangle-like, oval, ellipsoidal or similar, in particular polygonal, optionally also round, cross-section, can be formed so as to be approximately complementary to the shape of a saddle for the purpose of detachable fastening of the diffuser attachment on a helmet lamp, with recesses on the broad side in the form of an upside down “U” and, on the long side, drawn-out side parts of the housing (cf. FIG. 1 to 3) which, when the diffuser attachment is mounted ready for operation, cooperate with the socket region of the helmet lamp, for example by a clamping action, and typically rest thereon.

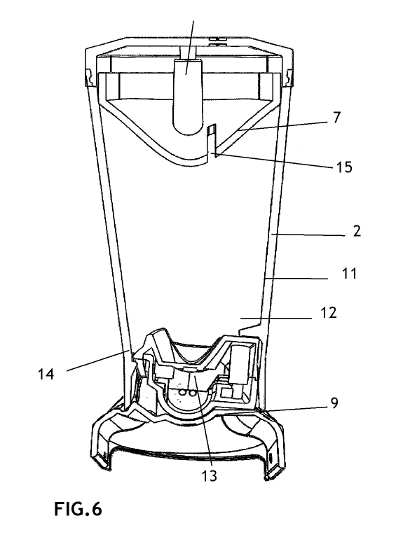

In order to ensure that the diffuser attachment rests in a stable manner on the helmet lamp, according to a preferred embodiment the housing 2 has, in the base region 6, at a predetermined distance from the lower edge of the open end 4 of one of the two longer side parts, at least one inward-facing first projection 12 (cf. FIG. 6) which is arranged on the inside 11 of the housing, and which, when the diffuser attachment is mounted ready for operation on the helmet lamp, rests on an abutment, typically a corresponding edge, on that upper side of the helmet lamp which is on the light exit side. This at least one first projection therefore acts firstly as a spacer for the correct positioning of the housing and secondly serves for stabilizing the position of the diffuser attachment on the helmet lamp in order to prevent any tilting away thereof. The first projection 12 may be, for example, in the form of two corner lugs or nipples or in the form of an elongated bulge or fold running in a cross-sectional plane of the diffuser attachment, on the inside of its housing, or such a bead, strip or projecting inner edge.

Where the term “upper side” or “light exit side” is used here in association with the helmet lamp, that side which has the exit opening for the light beam is meant thereby.

On that side of the housing wall which is opposite the first projection, the housing may have a further, inward-pointing, second projection 14 which cooperates in the manner of a fast-action coupling, for example of a snap coupling, with another edge on the upper side or a lateral region of the helmet lamp and detachably fixes the housing in this manner to the helmet lamp, said second projection 14 typically not being at the same height as said first projection.

Of course, the fast-action coupling may also have any other suitable form, for example the form of a groove which runs all round the lamp and into which the end 4 of the housing can be inserted to form an interlocking connection and can be held either by a clamping action or once again via a snap coupling mechanism. Particularly for lamps having a round cross-section, diffuser attachments according to the invention which, at their open end 4, have a round cross-section with an internal or external thread in the base region 6 and can be screwed onto the lamp with corresponding opposite thread are provided—as already mentioned further above. Bayonet couplings are also suitable, the open end 4 of the housing having, for example, an outward-directed collar positioned on at least one section, preferably on at least two sections, and being capable of being turned therewith into a corresponding retaining rail on the lamp and being firmly clamped or optionally fixed via a snap mechanism. In a simple but universally applicable embodiment, the diffuser attachment is adapted in the region of its open end 4 to the lamp equipped therewith in that, in this region, it at least approximately follows the outer contours of the lamp base, of the lamp holder or of the lamp socket and, in this region, has the broadest diameter, which is either slightly smaller than, equal to or greater than the corresponding largest diameter of the lamp base, lamp holder or lamp socket. In the case of a smaller diameter, the diffuser attachment can be pushed onto the lamp easily with application of pressure and is then firmly held there by a clamping action. For this purpose, it consists of an at least slightly extendable material, for example a suitable plastic material. If the open end 4 has the same diameter as or a larger diameter than the lamp base, lamp holder or lamp socket, the housing of the diffuser attachment can be completely inverted over the lamp and then fixed to the lamp base, lamp holder or lamp socket by clamping, for example by means of one, two or more adjusting or set screws mounted on the side of the housing. For this purpose, the lamp requires no opposite thread since the adjusting or set screws have external threads and are guided in corresponding openings in the region of the open end 4 of the diffuser attachment, which openings are provided with internal threads. These set or adjusting screws may be produced from a suitable plastic material and, for easier handling, have ribbed screw heads or screw heads equipped with small wings. Instead of the screws, however, it is also possible in principle to use spring-loaded clamping pins or bolts with a snap-in mechanism.

In addition, the diffuser attachment according to the invention, can, as shown in FIG. 6, be equipped with a suspending device 10 which permits suspension of a helmet lamp equipped therewith, for example in a tent or recreational vehicle. This suspension device is typically in the form of a hook, a bracket, an eye or a loop and attached in the region of the first end 3 of the housing.

The housing itself is typically produced from a transparent or translucent, preferably an impact-resistant and scratch-resistant, colorless or colored plastic but may also consist of such a glass, especially toughened glass.

In a particular embodiment, the diffuser mirror of the reflector element 7 may also have one or more, optionally slot-like, openings 15 through which a part of the light of the light source can pass and, for example, can illuminate a colorless or colored, transparent or translucent region in the cap 8 so as to be visible from the outside. Thus, a region may be, for example, in the form of lettering and/or a logo of the manufacturer.

### LIST OF REFERENCE NUMERALS

| | |
|---|---|
| 1 | Diffuser attachment for a helmet lamp |
| 2 | Transparent or translucent, sleeve-like housing |
| 3 | First end of the housing (top end) |
| 4 | Second end of the housing (base end) |
| 5 | Top region |
| 6 | Base region |
| 7 | Reflector element |
| 8 | Cap |
| 8a, 8b | First and second parts of a two-part cap |
| 9 | Helmet lamp |
| 10 | Suspension device |
| 11 | Inside of housing |
| 12 | First projection for stabilizing the attachment |
| 13 | Light source of the helmet lamp |
| 14 | Second projection for detachable locking of the attachment |
| 15 | Opening in the reflector element |

1. A diffuser attachment for a lamp, comprising a transparent or translucent, sleeve-like housing with a first, closed end and a second, open end opposite the first end, the first end being closed by a closure element and, together with this, forming a top region, the top region having, on its inside, a reflector element which is convex in the direction of the open end and in the form of a diffuser mirror, and the second end forming a base region, wherein the base region is adapted to the outer shape and geometry of lamp at least to such an extent that reversible inversion of the diffuser attachment over the lamp or reversible mounting of the diffuser attachment on the lamp and detachable fixing thereof to the lamp are possible, the reflector element of the light source being located centrally opposite and the distance between reflector element and light source of the lamp being at least 1 cm when the diffuser attachment is mounted ready for operation on the lamp.

2. The diffuser attachment as claimed in claim 1, wherein the lamp is a helmet lamp, a flashlight or an incandescent bulb with holder.

3. The diffuser attachment as claimed in claim 1, wherein it has, in the base region of its open end, fixing means which cooperate with corresponding fixing means of the lamp and make it possible reversibly to connect it to the lamp in the manner of a fast-action coupling.

4. The diffuser attachment as claimed in claim 3, wherein the housing has a square, rectangular, rectangle-like, polygonal, oval, elliptical or circular cross-section in the base region.

5. The diffuser attachment as claimed in claim 3, characterized in that it is formed in the manner of a plug attachment with snap coupling and has at least one first, inward-directed projection which is arranged on the inside of the housing and serves as a spacer and for mechanical stabilization of the diffuser attachment on a helmet lamp, the at least one first projection resting on an abutment on the upper side of the helmet lamp when the diffuser attachment is mounted ready for operation on the helmet lamp, while the corresponding end of the housing wall which carries this first projection cooperates with a base region of the helmet lamp and rests on said region.

6. The diffuser attachment as claimed in claim 5, wherein it has at least one second, inward-directed projection which is present on the inside of the housing opposite the first projection and which serves for detachable fixing of the diffuser attachment on the helmet lamp, the at least one second projection cooperating with an edge of a fast-action coupling present on the upper side of the helmet lamp, while at the same time the housing wall in the region of its open end cooperates with the helmet lamp via a clamping action and rests on a socket region of the helmet lamp.

7. The diffuser attachment as claimed in claim 1, wherein the second, open end of the housing is designed in its shape to be approximately complementary to a saddle, with drawn-out U-shaped recesses on the broad side and side wall parts extended in the opposite direction on the long side.

8. The diffuser attachment as claimed claim 1, characterized in that the cap is composed of two parts, comprises a first, approximately annular part, which carries the reflector element, and a second part which is formed as a cover and is detachably connected via at least one connecting element to the first part.

9. The diffuser attachment as claimed in claim 1, wherein the closure element is in the form of a separate cap which is connected via a fast-action coupling to the first end of the housing.

10. The diffuser attachment as claimed in claim 1, wherein it is equipped at the first end with a suspension device.

11. The diffuser attachment as claimed in claim 1, wherein the housing is in the form of an integral sleeve or a sleeve which may be composed of two or more parts and, at least in the region between open end and top region, said housing consists of a transparent or translucent, colorless or colored plastic or of such a glass.

12. The diffuser attachment as claimed in claim 1, wherein the reflector element has one or more openings through which a part of the light of the light source of the lamp can pass and can illuminate a colorless or colored, transparent or translucent region in the cap so as to be visible from the outside.

13. A method of use of a diffuser attachment as claimed in claim 1, comprising the for loose inversion over or detachable fixing of the diffuser attachment on a commercially available, portable lamp, for producing diffuse, anti-dazzle light and/or for improved spatial illumination of the nearer environment.

14. A lamp selected from the group consisting of a helmet lamp and a flashlight, equipped with a diffuser attachment as claimed in claim 1.

15. The diffuser attachment as claimed in claim 1, wherein the distance between reflector element and light source of the lamp being is from 1 to 20 cm.

16. The diffuser attachment as claimed in claim 3, wherein the fast-action coupling is selected from the group consisting of a snap, clamp, screw or bayonet coupling.

17. The diffuser attachment as claimed in claim 8, wherein the second part of cap is detachably connected via a plug connector to the first part.

18. The diffuser attachment as claimed in claim 9, wherein the fast-action coupling is selected from the group consisting of a snap, clamp, screw or plug connection.

19. The diffuser attachment as claimed in claim 10, wherein the suspension device is in the form of a hook, a bracket, an eye or a loop.

20. The diffuser attachment as claimed in claim 11, wherein said transparent or translucent, colorless or colored plastic or glass is impact-resistant and scratch-resistant.
